(19) United States
(12) Patent Application Publication
(10) Pub. No.: US 2011/0045885 A1
(43) Pub. Date: Feb. 24, 2011

(54) VIRTUAL CREATURE CHARACTER FOSTERING APPARATUS

(75) Inventor: Yukiko Onuki, Tokyo (JP)

Correspondence Address: RANKIN, HILL & CLARK LLP, 38210 GLENN AVENUE, WILLOUGHBY, OH, 44094-7808, US

(73) Assignee: KONAMI DIGITAL ENTERTAINMENT CO., LTD., Tokyo (JP)

(21) Appl. No.: 12/162,849

(22) PCT Filed: Jan. 31, 2007
(86) PCT No.: PCT/JP2007/051635

§ 371 Date: Jul. 31, 2008

(30) Foreign Application Priority Data
Feb. 1, 2006 (JP) 2006-025031

(51) Int. Cl. A63F 9/24; A63F 13/00

(52) U.S. Cl. 463/1; 463/31

(57) ABSTRACT

A virtual creature character fostering apparatus, which allows a user to understand by experience that passage of time and physical contact are important for fostering a virtual creature character, is provided. The virtual creature character fostering apparatus includes a temperature sensor 13 disposed inside a casing 1 to detect a temperature of the casing 1, character-to-be-fostered selecting means 21, display control means 23, timer means 29, and temperature-condition determination means 27. The timer means 29 counts a predetermined timer period and determines that the predetermined timer period has passed after the display control means 23 displays a previous growing image of the virtual creature character on an image display portion 4. The temperature-condition determination means 27 determines whether or not the casing has been warmed over a given time period after the timer means 29 completes counting of the timer period. The display control means 23 displays a subsequent growing image on the image display portion 4 if the temperature-condition determination means 27 determines that the casing 1 has been warmed over the given time period.

### TECHNICAL FIELD

The present invention relates to a virtual creature character fostering apparatus capable of displaying growing stages of a virtual creature character which is being fostered.

### BACKGROUND OF THE INVENTION

Japanese Patent Application Publication No. 07-160853 (JP07-160853A; Patent Document 1) discloses an image display device which detects ambient conditions with a temperature sensor and an illumination sensor, fosters a virtual creature using outputs from the temperature and illumination sensors as growth element data for the virtual creature, and displays a growing image thereof on an image display portion.

Japanese Patent Application Publication No. 2000-16948 (JP2000-116948; Patent Document 2) discloses an electronic apparatus which creates an unexpected virtual creature according to ambient conditions determined by outputs from an optical sensor and a temperature sensor, and displays an image of the virtual creature on an image display portion so that the virtual creature may be used in a game.

Further, Japanese Patent Application Publication No. 10-232595 (JP10-232595A; Patent Document 3) shows an example of a concrete configuration of a simulation apparatus which simulates a growing process of a virtual creature.

### DISCLOSURE OF THE INVENTION

### Problems to be Solved by the Invention

Conventionally-proposed simulation apparatuses which simulate the fostering process of a virtual creature character use outputs from a temperature sensor as conditions for growth or birth of the virtual creature character. In the conventional apparatuses, however, once the virtual creature character has been born, the outputs from the temperature sensor are merely used for detecting an ambient condition at a particular point of time in order to foster the virtual creature character. For this reason, although the conventional apparatuses allow a user to understand by experience that physical contact is important for healthily fostering a real living creature, but is not capable of fostering the virtual creature character. Accordingly, the user does not feel that the user is participating in the fostering of the virtual creature character.

Accordingly, an object of the present invention is to provide a virtual creature character fostering apparatus which allows the user to feel that the user is participating in the fostering of a virtual creature.

Another object of the present invention is to provide a virtual creature character fostering apparatus which allows the user to understand by experience that it is important to provide the time for physical contact for fostering a virtual creature character.

A further object of the present invention is to provide a virtual creature character fostering apparatus which allows the user to look forward to confirming growing states of a virtual creature character.

### Means of Solving the Problems

A virtual creature character fostering apparatus of the present invention includes a casing onto which an image display portion is fixed, a temperature sensor disposed inside the casing to detect a temperature of the casing, and display control means. The display control means displays an image of a virtual creature character on the image display portion, and uses an output from the temperature sensor as one of growth element data for promoting the growth of the virtual creature character. The display control means determines a growing image of the virtual creature character to be displayed on the image display portion based on the growth element data, and displays the growing image on the image display portion.

The virtual creature character fostering apparatus of the present invention further includes timer means and temperature-condition determination means. The timer means counts a predetermined timer period and determines that the predetermined timer period has passed after the growing image of the virtual creature character, which has been determined, is displayed on the image display portion. The temperature-condition determination means determines whether or not the casing has been warmed over a given time period after the timer means completes counting of the predetermined timer period. The display control means is configured to display a subsequent growing image of the virtual creature on the image display portion when the temperature-condition determination means determines that the casing has been warmed over the given time period. With such configuration, the user may understand that virtual creature characters cannot grow up merely by a simple behavior of warming, and passage of time plays an important role in fostering as with raising a real living creature. In addition, the user may understand that physical contact is important for healthily fostering a creature character as with when raising a real living creature because it is necessary to warm the casing over the given period.

In one or more embodiments of the present invention, the growth of the creature characters may be promoted not according to the requirement that the casing is continuously warmed over the given time period, but on condition that a predetermined timer period set by the timer means has passed and that the temperature of the casing has become a predetermined temperature. For that purpose, temperature-condition determination means may be configured to determine whether or not the casing has been warmed up to the predetermined temperature after the timer means completes counting of the predetermined timer period. The display control means may be configured to display a subsequent growing image of the virtual creature character on the image display portion when the temperature-condition determination means determines that the casing was once warmed up to the predetermined temperature. With such configuration, even little children may enjoy fostering because it becomes possible for them to foster the creature even if they do not warm the casing sufficiently. They may understand by experience that passage of time plays an important role in fostering.

Whether the passage of the predetermined timer period or completion of the warming behavior for the given time period is the primary condition is arbitrary. Accordingly, in one or more embodiments of the present invention, the temperature-condition determination means may determine whether or not the casing has been warmed over the given time period after the growing image of the virtual creature character, which has been determined, is displayed on the image display portion. In this case, the timer means starts counting the predetermined timer period and determines that the predetermined timer period has passed after the temperature-condition determination means determines that the casing has been warmed over the given time period. Then, after the timer means completes counting of the predetermined timer period, a subsequent growing image is displayed on the image display portion. With such configuration, the user may understand by experience that physical contact is important for healthily fostering the creature character as with when raising a real living creature because it is necessary to warm the casing over the given time period whenever a growing image thereof in the subsequent growing stage is newly displayed. Further, the user may understand that virtual creature characters cannot grow up merely by a simple behavior of warming, and that passage of time plays an important role in fostering as with when raising a real living creature.

In one or more embodiments of the present invention, the temperature-condition determination means may determine whether or not the casing has been warmed up to the predetermined temperature after the growing image of the virtual creature character, which has been determined, is displayed on an image display portion. In this case, the timer means starts counting the predetermined timer period and determines that the predetermined timer period has passed after the temperature-condition determination means determines that the casing has been warmed up to the predetermined temperature. Then a subsequent growing image is displayed on the image display portion after the timer means completes counting the predetermined timer period. In this manner, even little children may enjoy fostering without difficulty because it becomes possible for them to foster the creature even if they do not warm the casing sufficiently. Further, they may understand by experience that passage of time plays an important role in fostering.

Here, it is preferred that the predetermined temperature in the above-mentioned embodiments, which is set by the temperature-condition determination means, is a temperature above ordinary temperature and is defined based on the temperature of the casing when the casing is warmed by the body temperature of a human being. With such predetermined temperature setting, a displayed image may be prevented from being affected by ambient air etc. which may cause the displayed image to change, and the user may understand that physical contact is important for healthily fostering the virtual creature character as with when raising a real living creature because it is necessary to warm the casing with the body temperature.

The virtual creature character to be fostered may be determined in advance, or character-to-be-fostered selecting means may be further provided for selecting one or more virtual creature characters to be fostered among a plurality of kinds of virtual creature characters. Though how to configure the character-to-be-fostered selecting means is arbitrary, selection of the characters may be made based on an output from the temperature sensor. In this case, the display control means may be configured to first display an initial image of the one or more virtual creature characters on the image display portion based on a selection command, use an output from the temperature sensor as one of growth element data for promoting the growth of the one or more virtual creature characters selected by the character-to-be-fostered selecting means, determine a growing image of the one or more virtual creature characters to be displayed on the image display portion based on the growth element data, and display the growing image, which has been determined, on the image display portion.

More specifically, the character-to-be-fostered selecting means may be configured to operate as follows. First, the character-to-be-fostered selecting means calculates a time period during which the temperature of the casing detected by the temperature sensor is equal to or higher than the predetermined temperature above ordinary temperature (accumulated time length during which the temperature is equal to or higher than the predetermined temperature). Then, one or more virtual creature characters to be selected are determined among the plurality of kinds of virtual creature characters in accordance with the accumulated time length. More specifically, the predetermined temperature is above ordinary temperature and is defined based on the temperature of the casing when the casing is warmed by the body temperature of a human being.

Sometimes the user may want to return or restore the image display from a current image to an image in the previous growing stage. In this case, he image display may be restored by switch operation. Even in this case, it is not easy to restore the image display to the previous one if warming the casing is defined as a necessary condition for the image restoration. As a result, the user may experience that fostering is always accompanied by difficulties. To realize this, the display control means includes other temperature-condition determination means and image restoration command generating means. In said other temperature-condition determination means, a temperature, which is higher than the predetermined temperature set up for the temperature-condition determination means, is set as a preset temperature. Said other temperature-condition determination means determines whether or not the temperature of the casing has become the temperature which is equal to or higher than the preset temperature set in said other temperature-condition determination means based on the output from the temperature sensor. When said other temperature-condition determination means determines that the temperature of the casing has become equal to or higher than the preset temperature, the image restoration command generating means outputs to the display control means an image restoration command to restore a current image to a previous display image. As mentioned above, since the preset temperature which is higher than the predetermined temperature set in the temperature-condition determination means is used in said other temperature-condition determination means, warming (temperature) necessary for promoting the growth of the virtual creature character to a subsequent growing stage is distinguishable from warming (temperature) necessary for restoring or returning to a previous display image. As a result, malfunction may be prevented from occurring, and the user may experience that fostering is accompanied by difficulties. Thus, the user may feel that the user is really involved in the fostering.

The configuration of the image display portion is arbitrary. For example, the image display portion may include a display device disposed inside the casing and a view window portion disposed in the casing to allow the display device inside the casing to be viewed therethrough. In such configuration, the user cannot grasp the current state and growing process at the first glance of the casing. TA magnifying lens may be fit into the view window portion to enlarge the inside view. In such configuration, the user cannot grasp the current and growing process at the first glance of the casing. To know the current and growing process, the user has to look into the casing through the view window portion. That allows the user to feel as if the user was observing hatching of a living creature under a microscope etc., and feel as if the virtual creature character was really living inside the casing, thereby increasing the user's interest.

Preferably, the temperature sensor may be installed in the casing with a sensor portion thereof being in contact with an inner wall surface of the casing. In this manner, a change in the temperature of the casing may directly be detected, thereby improving responsiveness.

### BRIEF DESCRIPTION OF THE DRAWINGS

FIGS. 1A to 1C are a perspective view, a front view, and a right side view of an external appearance of a virtual creature character fostering apparatus according to one embodiment of the present invention.

FIGS. 2A and 2B are a vertical sectional view and a perspective view, in which a casing is partially omitted to show the inside, of the embodiment of FIG. 1.

FIG. 3 shows a typical screen of a display device.

FIG. 4 illustrates an example where the casing is forcibly warmed.

FIG. 5 is a block diagram showing a configuration of a main part of a control circuit mounted on a circuit substrate.

FIG. 6A shows an image displayed on the screen before a virtual creature character is born, and FIG. 6B shows initial images of a plurality of virtual creature characters.

FIG. 7 shows gradual growing stages from birth to maturity of the plurality of virtual creature characters.

FIG. 8 is a flowchart showing a part of programming algorithm applied in implementing character-to-be-fostered selecting means using a microcomputer.

FIG. 9 is a flowchart showing a part of programming algorithm applied in implementing character-to-be-fostered selecting means using a microcomputer.

FIGS. 10A and 10B are flowcharts schematically showing two basic operational algorithms in a fostering process.

FIGS. 11A and 11B are flowcharts schematically showing another two basic operational algorithms in a fostering process.

FIG. 12 is a flowchart showing an example algorithm when a second temperature-condition determination means is used.

FIG. 13 is a flowchart schematically showing a basic algorithm of another embodiment of the present invention.

### BEST MODE FOR CARRYING OUT THE INVENTION

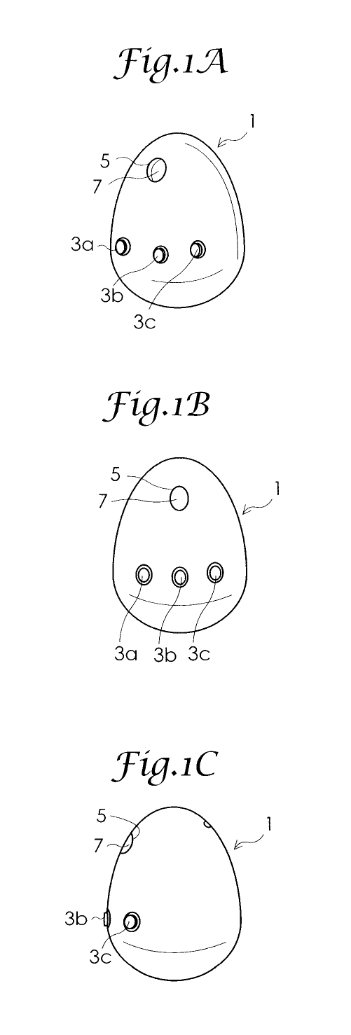

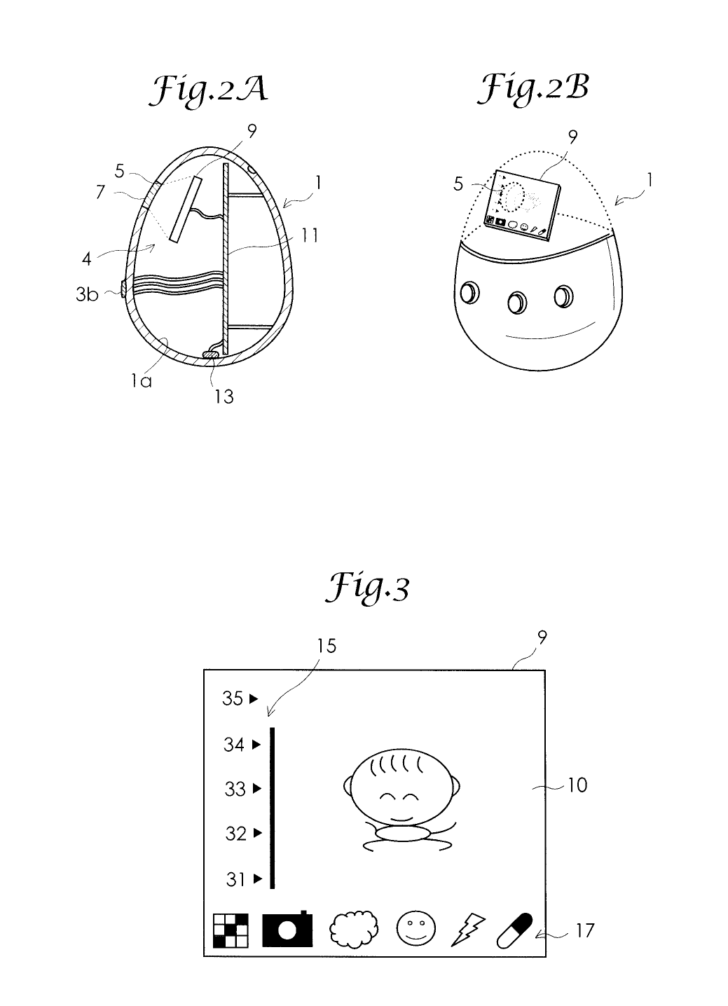

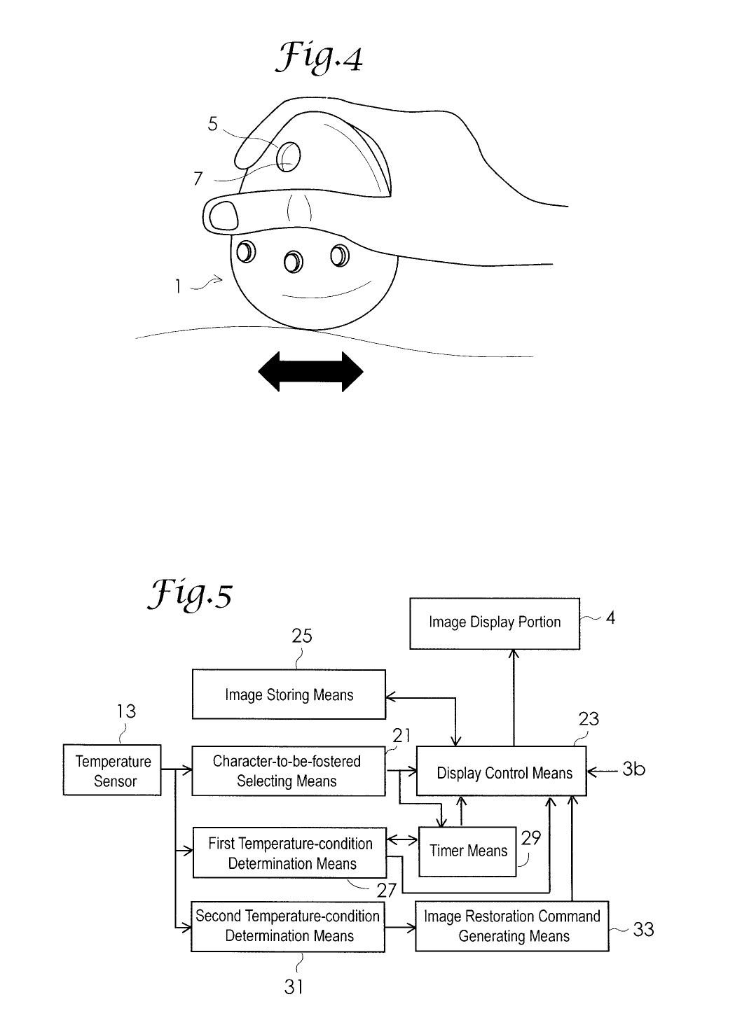

The best mode for carrying out the invention will now be hereinafter described in detail with reference to the accompanying drawings. FIGS. 1A to 1C are a perspective view, a front view, and a right side view of an external appearance of a virtual creature character fostering apparatus according to one embodiment of the present invention. FIGS. 2A and 2B are a vertical sectional view and a perspective view, in which a casing is partially omitted to show the inside, of the embodiment of FIG. 1. The apparatus includes an egg-shaped casing 1. Though not shown, the casing 1 is formed by combining a pair of casing half-portions, each of which is a vertically-cut half-portion of the casing. Three operation switches 3a to 3c are arranged on a lower portion of the casing 1. The operation switches 3a to 3c work as an electric power switch, a command input switch, and an icon selection switch, etc. A view window portion 5 is arranged on an upper portion of the casing 1. A magnifying lens 7 is fit into the view window portion 5 to enlarge the inside view. Inside the casing 1, a display device 9, which is constituted from a liquid crystal panel or the like, is disposed in a location which can be seen through the magnifying lens 7 of the view window portion 5. In the present embodiment, an image display portion 4 is constituted from the view window portion 5, the magnifying lens 7, and the display device 9. Although not shown, the display device 9 is fixed to the casing 1 via a circuit substrate 11. The type of the magnifying lens 7 and setting angle of the display device 9 are determined so that the screen of the display device 9 can be fully viewed when the user looks into the casing 1 through the view window portion 5 with one eye, as shown in FIG. 3.

Although not shown, a power supply circuit which uses a battery as a power source, a display device drive circuit, a control circuit including a microcomputer as arithmetic processing means, and other parts are mounted on the circuit substrate 11. A temperature sensor 13, for example a thermistor, is installed inside the casing 1 with a sensor portion thereof being in direct contact with an inner wall surface la of the casing 1. The temperature sensor 13 is attached onto the inner wall surface of a bottom region of the egg-shaped casing 1. Outputs from the temperature sensor 13 are processed by a control circuit, not shown, mounted on the circuit substrate 11.

In the present embodiment, as shown in FIG. 3 as one example of a display screen 10 of the display device 9, the display device 9 always displays on the display screen a temperature indicator 15 which indicates a temperature of the casing 1 detected by the temperature sensor 13 and an icon display portion 17 which displays six icons selected by any one of the operation switches 3a and 3b. The temperature indicator 15 is configured to show the temperature detected by the temperature sensor 13 in a bar graph. An image displayed in the center of FIG. 3 is a selected virtual creature character as explained later.

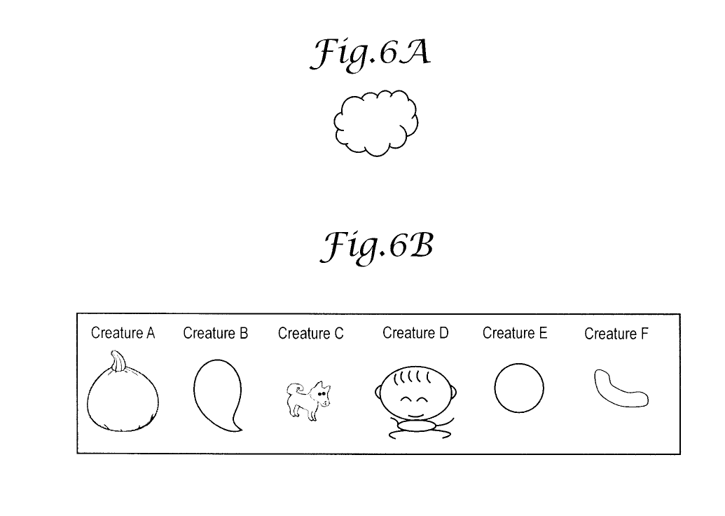

To operate the virtual creature character fostering apparatus, the user may warm the casing 1 by wrapping it with hands or keeping it in contact with the skin of a human being. Alternatively, the casing 1 may forcibly be warmed by rubbing a bottom portion of the casing 1 on the arm or thigh of a human being via clothes, as shown in FIG. 4. Above all, to increase the temperature of the casing 1 in a short time, it is the most effective to rub the casing against something as shown in FIG. 4.

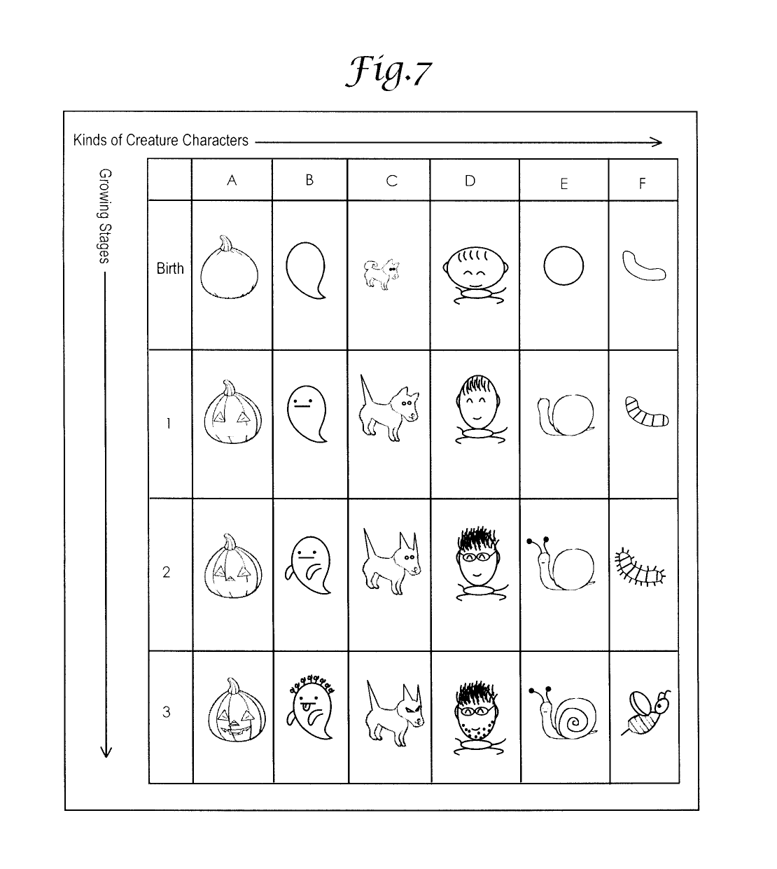

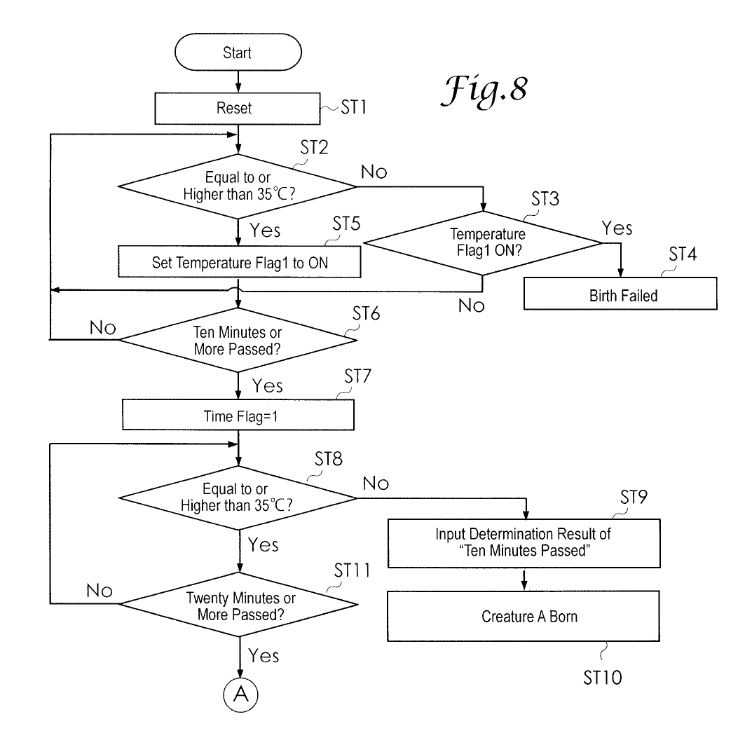

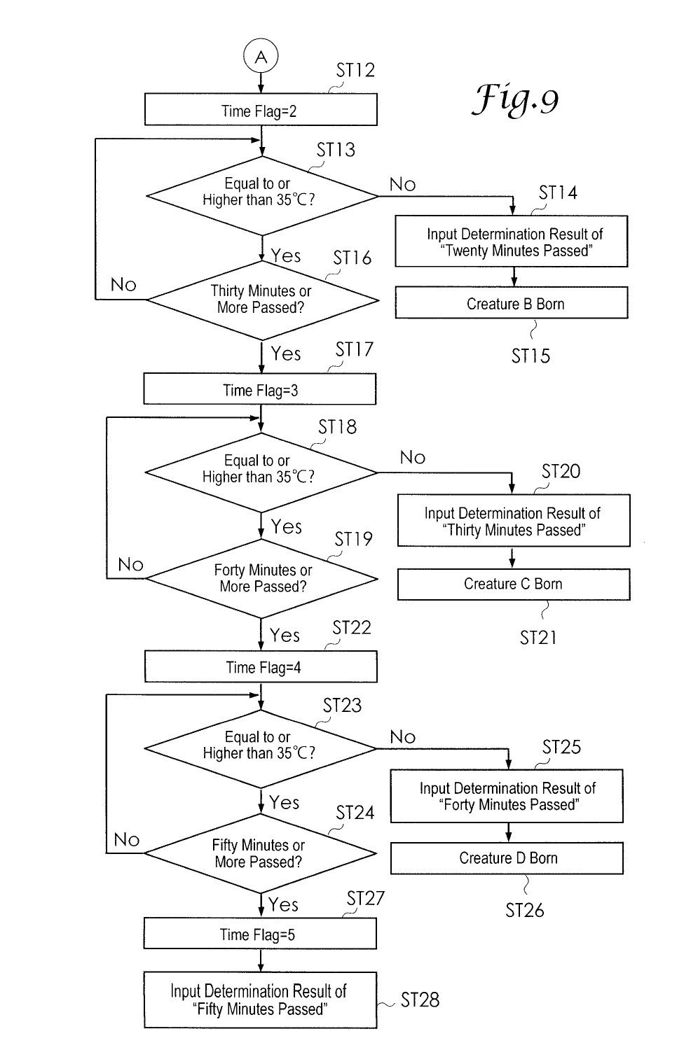

FIG. 5 is a block diagram showing a configuration of a main part of the control circuit mounted on the circuit substrate 11. The main part of the control circuit 11 shown in FIG. 5 includes character-to-be-fostered selecting means 21, display control means 23, image storing means 25, first temperature-condition determination means 27, timer means 29, second temperature-condition determination means 31, and image restoration command generating means 33. The image storing means 25 stores an image representing an unknown state where no virtual creature character is born yet, as shown in FIG. 6A, images of a plurality of kinds of virtual creature characters A to F each representing a newborn appearance thereof, as shown in FIG. 6B, and images or image units of the plurality of kinds of virtual creature characters corresponding to respective growing stages thereof from birth to maturity, as shown in FIG. 7. In FIGS. 6 and 7, creatures A to F are shown as examples of six kinds of virtual creature characters. A virtual creature character is not limited to the examples shown in FIGS. 6 and 7, and any kind of creatures may be applied as long as they can be born and grow up. For example, a virus, a bacterium, a microorganism, a monster, or even a fictitious creature may be applied. The term “growth” or “fostering” used herein may represent a change in the appearance of a character as with the growth of a human being from an infant to an adult, but may represent a process in which a character is born imperfectly with some parts of the body thereof missing, and then the missing parts are successively added to the body to form the perfect virtual creature character, as shown in FIG. 7. The term “image” used herein means both of a static image and an animated image.

The character-to-be-fostered selecting means 21 of FIG. 5 outputs to the display control means 23 a selection command to select one or more virtual creature characters among the plurality of kinds of virtual creature characters based on an output from the temperature sensor 13. The display control means 23, in response to the selection command, reads out an initial image (from among the images of FIG. 6B, or the images in the “birth” row in FIG. 7) of the selected virtual creature character from the image storing means 25, and displays the image on the image display portion 4.

This example assumes that one virtual creature character is selected. When selecting a plurality of virtual creature characters, virtual creature characters of the same kind or different kinds may be selected.

In this example, as shown in FIG. 6A, before the character-to-be-fostered selecting means 21 outputs a selection command, a hazy cloud-like object, which represents an unknown state where no virtual creature character is born yet, is displayed on the display screen of the display device 9. First, the character-to-be-fostered selecting means 21 calculates an accumulated time length during which the temperature of the casing 1 detected by the temperature sensor 13 is equal to or higher than a predetermined temperature above ordinary temperature. Then, a virtual creature character to be fostered is determined among the creatures A to F, or the plurality of kinds of virtual creature characters, in accordance with the accumulated time length, and one of the initial images (images of FIG. 6B or images of the “birth” row in FIG. 7) of the virtual creature characters, which represents a newborn appearance thereof is displayed on the display screen 10. More specifically, the predetermined temperature above ordinary temperature is defined based on the temperature of the casing 1 when the casing is warmed by the body temperature of a human being. Incidentally, in the present embodiment, although the predetermined temperature is set to 35° C. as will be explained in detail later, it is not limited to this temperature.

In the present embodiment, the accumulated time length at the time of birth, during which the temperature of the casing 1 is equal to or higher than the predetermined temperature above ordinary temperature, is a time period during which the temperature sensor 13 is continuously detecting a temperature which is equal to or higher than the predetermined temperature. Accordingly, if the warming behavior is given up on the way, it may happen that no virtual creature character should be born. Thus, the user may understand that it is important for the birth of a virtual creature character to continue the warming behavior for a given time period just like it is necessary to warm an egg for a given time period to give birth to a real creature from the egg, and may feel that the user is participating in the birth of the virtual creature character.

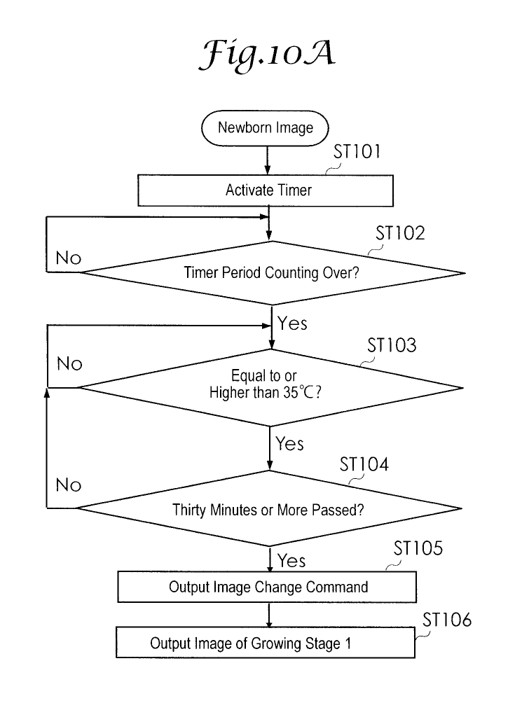

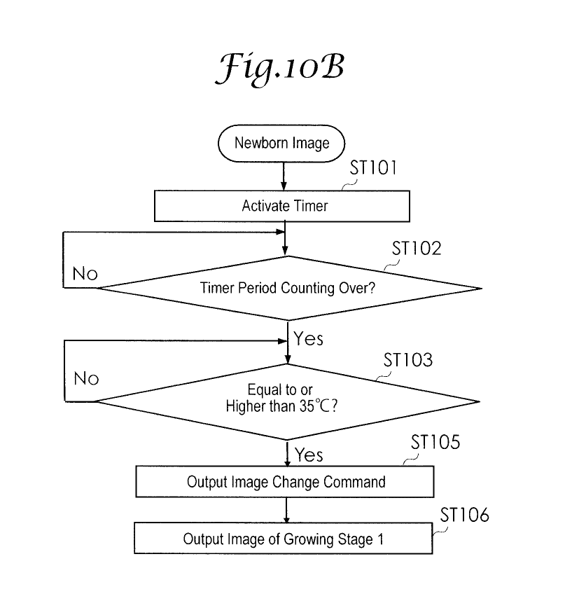

FIGS. 8 and 9 are flowcharts showing a programming algorithm applied in implementing character-to-be-fostered selecting means 21 using a microcomputer. The first half steps are shown in FIG. 8 and the latter half steps are shown in FIG. 9. In this example, one virtual creature character is selected among four kinds of virtual creature characters. The number of the selectable characters is arbitrary. As shown in FIG. 8, first, the program is reset in step ST1. In step ST2, it is determined whether or not the temperature of the casing 1 detected by the temperature sensor 13 is equal to or higher than 35° C. If the temperature is lower than 35° C., the process proceeds to step ST3 where it is determined whether or not temperature flag1 is ON. If temperature flag1 is not ON, the process returns to step ST2, and if temperature flag1 is ON, it proceeds to step ST4 where birth fails. Namely, as long as the temperature of the casing 1 is not equal to or higher than 35° C., it is always impossible to select any virtual creature character.

If it is detected in step ST2 that the temperature of the casing 1 is equal to or higher than 35° C., the process proceeds to step ST5 and temperature flag1 is set to ON. Then the process proceeds to step ST6 where it is determined whether or not ten minutes or more have passed since the warming behavior started. If ten minutes have not passed yet, the process returns to step ST2, and if ten minutes have passed, it proceeds to step ST7 where a time flag is set to “1”. Then the process proceeds to step ST8. Instep ST8, it is determined whether or not the temperature of the casing 1 detected by the temperature sensor 13 is equal to or higher than 35° C. If the temperature is below 35° C., the process proceeds to step ST9 where a determination result that ten minutes have passed with the temperature being kept equal to or higher than 35° C. is inputted. Then in step ST10, the selection command to give birth to creature A, selected among a plurality of kinds of virtual creature characters, is outputted. If it is determined in step ST8 that the temperature is equal to or higher than 35° C., the process proceeds to step ST11 where it is determined whether or not twenty minutes have passed. If twenty minutes have not passed, the process returns to step ST8 and if twenty minutes have passed, it proceeds to step ST12 of FIG. 9. In step ST12, the time flag is set to “2” and the process proceeds to step ST13. If the temperature is lower than 35° C. in step ST13, the process proceeds to step ST14 where a determination result that twenty minutes have passed with the temperature being kept equal to or higher than 35° C. is inputted. Then in step ST15, a selection command to give birth to creature B, selected among the plurality of kinds of virtual creature characters, is outputted.

If it is determined that the temperature is equal to or higher than 35° C. in step ST13, the process proceeds to step ST16 where it is determined whether or not thirty minutes have passed. If thirty minutes have not passed, the process returns to step ST13. If thirty minutes have passed, it proceeds to step ST17 where the time flag is set to “3”. Then the process proceeds to step ST18. As with the process as described above, a determination result that thirty minutes have passed with the temperature being kept equal to or higher than 35° C. is inputted in step ST20 and a selection command to give birth to creature C, selected among the virtual creature characters, is outputted in step ST21. If it is determined in step ST25, that a warmed condition equal to or higher than 35° C. has been continued for forty minutes or more and less than fifty minutes, after going through steps ST19, ST22, and ST23, a determination result that forty minutes have passed with the temperature being kept equal to or higher than 35° C. is inputted. Then in step ST26, a selection command to give birth to creature D, selected among the virtual creature characters, is outputted. In this example, if it is detected through steps ST24, ST27, and ST28 that a temperature equal to or higher than 35° C. has been continued for fifty minutes or more, the process proceeds to a subsequent routine. What is processed in the subsequent routine is arbitrary. For example, it may be indicated that warming is excessive and the user may be encouraged to make another challenge, or a selection command may be outputted to select creature D as a virtual creature character whenever the warmed condition equal to or higher than 35° C. has been continued for fifty minutes or more.

In the above-mentioned program, although a selection command to select the kind of virtual creature character to be born is outputted in accordance with the accumulated time length during which the temperature of the casing 1 is continuously equal to or higher than the predetermined temperature of 35° C., the accumulated time length may be a summation of time periods during which the temperature sensor 13 is detecting a temperature which is equal to or higher than the predetermined temperature. With such summation, even when the user who is not familiar with how to warm gives up warming on the way, the user may still give birth to a new or unexpected virtual creature character.

Referring back to FIG. 5, when the character-to-be-fostered selecting means 21 outputs a selection command to display one or more virtual creature characters selected among the plurality of kinds of virtual creature characters, the display control means 23 reads out an image which represents a newborn stage of the selected virtual creature character from the image storing means 25 in response to the command, and displays the image on the image display portion 4.

After the virtual creature character to be fostered has been determined, a growing image of the virtual creature character is displayed by operation of the display control means 23. In the present embodiment, after the initial image of the virtual creature character has been displayed on the image display portion 4 in response to the selection command, an output from the temperature sensor 13 is used as one of growth element data for promoting the growth of the virtual creature character selected by the character-to-be-fostered selecting means 21. The display control means 23 determines a growing image of the virtual creature character to be displayed on the image display portion 4 based on the growth element data, and displays the growing image on the image display portion 4.

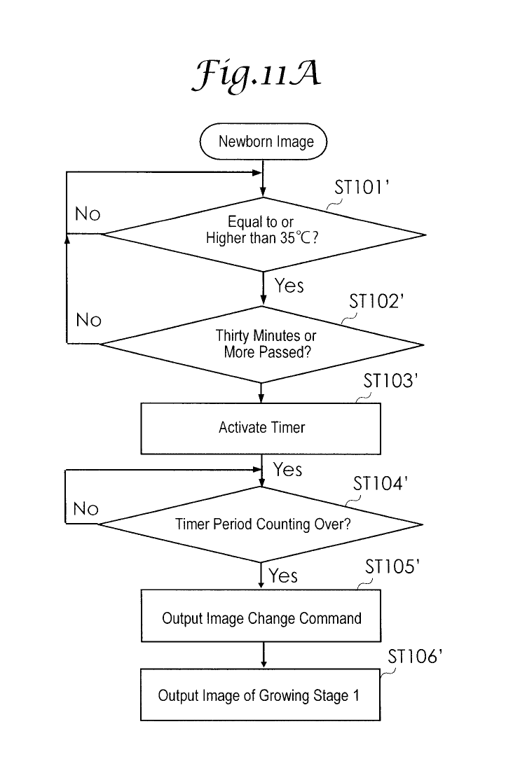

In the present embodiment, the display control means uses the timer means 29 and the first temperature-condition determination means 27 to utilize in a fostering process outputs from the temperature sensor 13 which detects a warmed condition (temperature) of the casing 1. FIG. 10A is a flowchart schematically showing a basic operational algorithm in a fostering process. In step ST101, the timer means 29 shown in FIG. 5 starts counting of a timer period after the display control means displays an initial image of the virtual creature character, (images selected from among FIG. 6B and those in the “birth” row in FIG. 7), which represents a newborn stage thereof, on the image display portion 4. If it is determined that the counting of the timer period has been completed in step ST102, the process proceeds to step ST103. Preferably, the timer period maybe set comparatively long. For example, in the present embodiment, the timer period is set to 24 hours or one day. With this timer period setting, the user may feel that it takes a long time for a virtual creature characters to grow up by one stage, namely, from one state to a next stage, thereby increasing the user's expectation for a new appearance of the grown-up character as with when raising a real living creature.

After the timer means 29 completes counting of a predetermined timer period, the first temperature-condition determination means 27 determines in steps ST103 and ST104 whether or not the temperature of the casing 1 has been continuously equal to or higher than 35° C. for thirty minutes or more. If the first temperature determination means 27 determines in steps ST103 and ST104 that the temperature of the casing 1 has been continuously equal to or higher than 35° C. for thirty minutes or more, it outputs an image change command to the display control means 23 in step ST105. In step ST106, in response to the image change command, the display control means 23 reads out a growing image of the corresponding virtual creature character in a subsequent growing stage stored in the image storing means 25, and displays the growing image, replaces the previous image with this read-out image, and displays the image on the image display portion 4. Namely, the displayed image is changed from an initial image (newborn stage) to a growing image in a stage subsequent to the newborn stage (growing stage 1) as shown in the growing stages of FIG. 7. From this point on until the last image change command is outputted, the process repeatedly returns to step ST101 whenever an image grown-up by one stage has been displayed on the image display portion 4, and a subsequent growing image is displayed in step ST106. After another timer period counting has been completed, the casing is warmed again. The character is thereby growing up to a subsequent growing stage on condition that a temperature equal to or higher than 35° C. has been continued for thirty minutes or more. In this manner, the growing image of the character is changing step by step in the order of newborn stage, growing stage 1, growing stage 2, and growing stage 3 as shown in FIG. 7. When such basic algorithm is adopted, the user may understand that virtual creature character cannot grow up merely by a simple behavior of warming, and that passage of time is also very important for fostering. Accordingly, the user may take the time and enjoy fostering leisurely. Further, the user may understand by experience that physical contact is important for healthily fostering a creature character as with when raising a real living creature because the user has to warm the casing 1 over the given time period whenever the predetermined timer period has been passed since a subsequent growing image of the virtual creature character was newly displayed.

According to the above-mentioned embodiment, the virtual creature character can grow up by one stage on condition that the temperature sensor 13 is continuously detecting a temperature. However, when the user is a small child, it may happen that the user does not continuously warm the casing 1. Then, such requirement may not be provided that the casing 1 should continuously be warmed. As a necessary condition for fostering, a predetermined timer set up in advance in the timer means should be counted, or the temperature of the casing 1 should reach the predetermined temperature. FIG. 10B is a flowchart schematically showing a basic operational algorithm when such requirements are provided, and is different from FIG. 10A in that step ST104 is omitted. If counting of the predetermined timer period is completed after a given initial image of the virtual creature character has been displayed, and the temperature of the casing 1 has once become 35° C. or more in step ST103, it is considered that the warming requirements for changing display images are satisfied, and an image change command is outputted in step ST105. Then, in step ST106, an image of the virtual creature character in a subsequent growing stage is displayed in response to this image change command. As with the process shown in FIG. 10A, the process repeatedly returns to step ST101 whenever a new image is displayed. Namely, until the last image change command is outputted, the process repeatedly returns to step ST101 whenever a growing image one stage by one stage is displayed on the image display portion 4, and a subsequent growing image is displayed in step ST106.

In this manner, even little children may enjoy fostering without difficulty because it becomes possible to foster the creature even if they do not warm the casing sufficiently. Further, they may understand by experience that passage of time plays an important role in fostering.

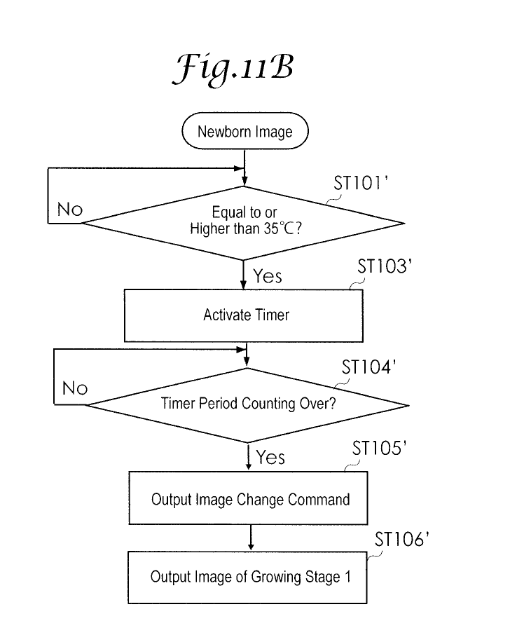

Alternatively, as shown in FIG. 11A, the basic operational algorithm may be configured as follows. After a given image of the virtual creature character has been displayed, the timer means 29 starts counting of a timer period in step ST103′ on condition that the first temperature-condition determination means 27 is detecting a temperature equal to or higher than 35° C. for thirty minutes or more in Steps ST101′ and ST102′. Then an image change command is outputted in step ST105′ on condition that the counting of the timer means 29 has been completed in Step ST104′. Preferably, the timer period may be set comparatively long. Until the last image change command is outputted, the process repeatedly returns to step ST101′ whenever a growing image one stage by one stage is displayed on the image display portion 4, and a subsequent growing image is displayed in step ST106′.

In the present embodiment, the timer period is set to 24 hours or one day. With this timer period setting, the user may feel that it takes a long time for a virtual creature character to grow up by one stage, namely, from one state to a next stage. A growing image of the virtual creature character is displayed on condition that the casing 1 has continuously been warmed for the predetermined period whenever an image of a new virtual creature character is displayed, and that the predetermined timer period has passed after the casing has been warmed. In this manner, the user may understand by experience that physical contact is important for healthily fostering the virtual creature character as with when raising a real living creature because it is necessary to warm the casing 1 for the given time period whenever an image of the virtual creature character in the subsequent growing stage is newly displayed. Further, the user may understand that virtual creature characters cannot grow up merely by a simple behavior of warming, and that passage of time plays an important role in fostering as with when raising a real living creature.

FIG. 11B is another example of algorithm, which is different from FIG. 11A in that step ST102′ is omitted. In this example, the algorithm may be configured as follows. Once a temperature of the casing 1 which is equal to or higher than 35° C. has been detected by the temperature-condition determination means 27 in step ST101′ as with the algorithm shown in FIG. 10B, the timer means 29 starts counting of the timer period in step ST103′. An image change command may be outputted if the timer means 29 completes the counting of the timer period in step ST104′. Until the last image change command is outputted, the process repeatedly returns to step ST101′ whenever a growing image one stage by one stage is displayed on the image display portion 4, and a subsequent growing image is displayed in step ST106′.

In this manner, even children may enjoy fostering without difficulty because it becomes possible to foster the creature even if they do not warm the casing sufficiently. Further, they may understand by experience that passage of time plays an important role in fostering.

In the above-mentioned embodiment, although the predetermined temperature for the first temperature-condition determination means 27 is set to 35° C. or more, the temperature predetermined by the temperature-condition determination means 27 is not limited to this setting. It is preferred that the predetermined temperature is higher than ordinary temperature and is defined based on the temperature of the casing 1 when the casing is warmed by the body temperature of a human being (specifically, around 30° C. to 37° C.). When the first temperature-condition determination means 27 is set up in this manner, a displayed image may be prevented from being affected by ambient air etc. winch may cause the displayed image to change. In addition, the user may understand by experience that physical contact is important for healthily fostering a creature character as with when raising a real living creature because it is necessary to warm the casing 1 with the user's body temperature.

In the course of fostering, the user may sometimes want to return the image display from the current one to a previous growing stage. Of course, the apparatus may be configured to return a display image by means of switch operation. However, if warming behavior is defined as a necessary condition for changing the image display, it is not easy to return the image display to a previous one. As a result, the user may experience that fostering is always accompanied by difficulties, thereby refraining from easily changing the fostering policy. Since the user understands difficulty in the course of fostering as with when the user actually fosters a real living creature, the user may feel more identified with the virtual creature character that the user is fostering. To realize this, the second temperature-condition determination means 31 and the image restoration command generating means 33 are provided in connection with the display control means 23, as shown in FIG. 5. As for the second temperature-condition determination means 31, a temperature, which is higher than the predetermined temperature set up for the character-to-be-fostered selecting means 21 and first temperature-condition determination means 27, is set up as a preset temperature. Specifically, it is preferred that the preset temperature is in the range of 40° C. to 46° C. The second temperature-condition determination means 31 determines whether or not the temperature of the casing 1 has become a temperature which equal to or is higher than the preset temperature based on an output from the temperature sensor 13. When the second temperature-condition determination means 31 determines that the temperature of the casing 1 has become the temperature which is equal to or higher than the preset temperature, the image restoration command generating means 33 outputs to the display control means 23 an image restoration command to return the display image from a current display image to a previous one. The display control means 23 reads out a previous image data or corresponding growing image in the previous stage from the image storing means 25 in response to the image restoration command and replaces the display image. As described above, since the preset temperature which is higher than the predetermined temperature is used in the second temperature-condition determination means 31, warming (temperature) required for usual fostering is definitely distinguishable from warming (temperature) required for returning the display image to a previous one. As a result, malfunction may be prevented from occurring, and the user may experience that fostering is accompanied by difficulties. Thus, the user may feel that the user is really involved in the fostering.

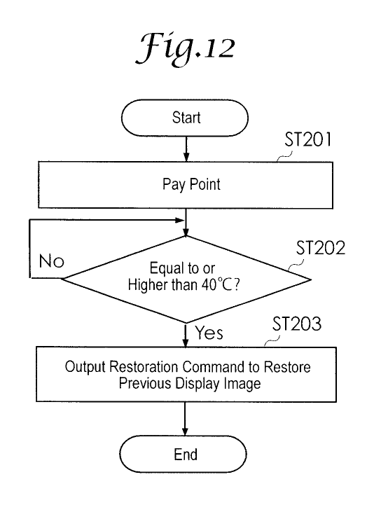

FIG. 12 is a flowchart showing an example algorithm when the second temperature-condition determination means 31 is used. In this example, payment of a point is required in step ST201. Namely, to return the display image from a current one to a previous one, it is required to pay a given point from among points the user have collected in some way or owned from the beginning. After a given point has been paid in step ST201, it is determined whether or not the temperature of the casing 1 has become the preset temperature 40° C. or more. If the temperature has not become 40° C., the process returns to step ST202. If the temperature has become 40° C. or more, the process proceeds to step ST203 where an image restoration command is outputted to readout an image of a previous growing stage.

According to the above-mentioned embodiment, determination of a virtual creature character to be fostered is made among a plurality of kinds of virtual creature characters, provided that the temperature sensor 13 is continuously detecting the temperature. However, if the user is a small child, it may happen that the user does not continuously warm the casing 1.

In another embodiment of the present invention, even if the temperature sensor is not continuously detecting the temperature, determination of a virtual creature character to be fostered may be made in a simple manner, for example, by inputting a determination command by means of switch operation, provided that the casing 1 was warmed and the temperature sensor has detected a given temperature even once.

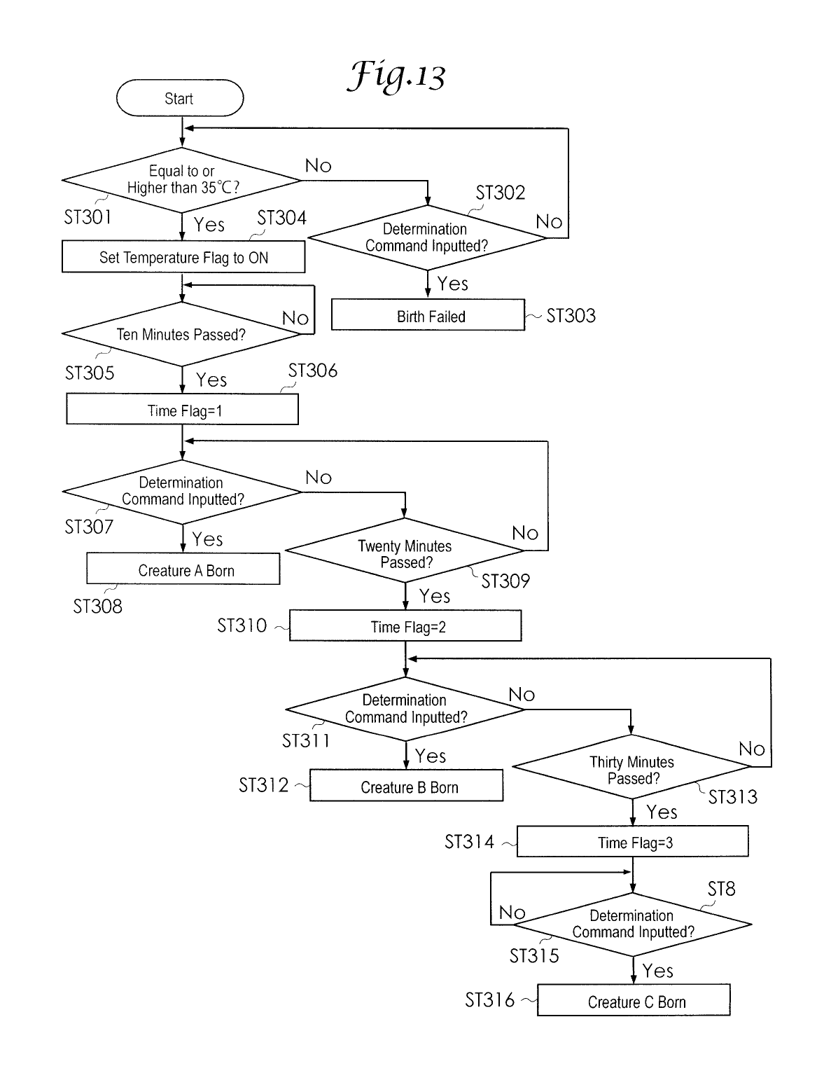

FIG. 13 is a flowchart showing an example algorithm to be applied when determining one virtual creature character to be fostered among a plurality of kinds of virtual creature characters through a warming behavior and an input operation of a determination command as described above. More specifically, one or more virtual creature characters to be fostered are determined among the plurality kinds of virtual creature characters in accordance with an accumulated time length after the temperature of the casing 1 detected by the temperature sensor 13 has become the predetermined temperature 35° C. or more till the determination command is inputted, and an initial image representing a newborn stage of the one or more virtual creature characters is displayed. To execute the algorithm, the character-to-be-fostered selecting means 21 is configured to include a determination command input means for inputting a determination command. In the present embodiment, although not shown in FIG. 5, any one of the switches 3a to 3c appearing in FIG. 1 is used as the determination command input means. During a time period after the temperature sensor 13 has detected the predetermined temperature till the determination command is inputted, a hazy cloud-like object, which represents an unknown state where no virtual creature character is born yet, is displayed on the display screen 10 of the display device 9 as shown in FIG. 6A. Then in step ST301, it is determined whether or not the temperature of the casing 1 detected by the temperature sensor 13 has become a temperature which is equal to or higher than the predetermined temperature 35° C. If the determination command is inputted before the temperature of casing 1 becomes the predetermined temperature 35° C., the process goes through steps ST302 and ST303, and birth of virtual creature fails. If the temperature detected by the temperature sensor has become 35° C. in step ST301, a temperature flag is set to ON in step ST304, and it is determined in step ST305 whether or not ten minutes have passed since it was detected in step ST301 that the temperature had become 35° C. or more. If it is determined that ten minutes have passed, the time flag is set to “1” in step ST306. Then, if a determination command is inputted before it is counted in step ST309 whether or not twenty minutes have passed, the process goes through step ST307 to step ST308 where creature A is born, selected from among the virtual creature characters. If it is counted in step ST309 that twenty minutes have passed, the time flag is set to “2” in step ST310. If a determination command is inputted after twenty minutes have passed before thirty minutes have passed, the process goes through step ST311 to step ST312 where creature B is born, selected from among the virtual creature characters. After it is counted in step ST313 that thirty minutes have passed, the time flag is set to “3” in step ST314. From this point on, if a determination command is inputted, the process goes through step ST315 to step ST316 where creature C is born, selected from among the virtual creature characters. As mentioned above, in the algorithm of FIG. 13, it is determined whether or not the determination command is inputted in steps ST302, ST307, ST311, and ST315. Insteps ST305, ST309, and ST313, it is detected how much time has passed since the predetermined temperature was detected in step ST301. In this manner, once a temperature of the casing 1 equal to or higher than the predetermined temperature has been detected and a given time has passed, the accumulated time length may be determined by the timing at which the determination command is inputted. Even if the warming behavior is not appropriate, a little child may use the game apparatus of the present invention.

According to the above-mentioned embodiment, although the predetermined temperature detected by the temperature sensor 13 is set to 35° C. or more, it is not limited to this setting.

In the above-mentioned embodiment, although the casing 1 is oval like an egg in shape, it is not limited to this shape and any shape may be applied as long as it can be warmed by hands. In the above-mentioned embodiment, an image displayed on the image display portion can be seen through the view window 5 disposed in the casing 1. However, the present invention is applied not only to such configuration having an image display portion as mentioned above, and of course it may also be applied to a publicly known configuration of an image display portion of which a display screen is exposed on the surface of the casing and other configurations of image display portions.

### INDUSTRIAL APPLICABILITY

In the present invention, how to warm or how long the casing is warmed, and the length of a waiting period are prerequisites or necessary conditions for fostering a virtual creature character. Accordingly, the user may understand by experience that a virtual creature character cannot grow up merely by a simple behavior of warming and passage of time plays an important role in fostering as with a real living creature. This allows the user to experience a physical contact through the behavior of warming and enjoy fostering leisurely.

1. A virtual creature character fostering apparatus comprising:
a casing onto which an image display portion is fixed;
a temperature sensor disposed inside the casing to detect a temperature of the casing;
display control means which displays an image of a virtual creature character on the image display portion, uses an output from the temperature sensor as one of growth element data for promoting the growth of the virtual creature character, determines a growing image of the virtual creature character to be displayed on the image display portion, based on the growth element data, and displays the growing image on the image display portion;
timer means which counts a predetermined timer period and determines that the predetermined timer period has passed after the growing image of the virtual creature character, which has been determined, is displayed on the image display portion; and
temperature-condition determination means which determines whether or not the casing has been warmed over a given time period after the timer means completes counting the predetermined timer period, wherein
the display control means is configured to display a subsequent growing image of the virtual creature on the image display portion when the temperature-condition determination means determines that the casing has been warmed over the given time period.

2. The virtual creature character fostering apparatus according to claim 1, further comprising character-to-be-fostered selecting means which outputs a selection command to select one or more virtual creature characters to be fostered among a plurality of kinds of the virtual creature characters, based on the output from the temperature sensor, wherein
the display control means is configured to display an initial image of the one or more virtual creature characters on the image display portion based on the selection command, determine a growing image of the one or more virtual creature characters to be displayed on the image display portion based on the growth element data, and display the growing image on the image display portion.

3. (canceled)

4. (canceled)

5. The virtual creature character fostering apparatus according to claim 1, wherein the image display portion includes a display device disposed inside the casing and a view window portion disposed in the casing to allow the display device inside the casing to be viewed therethrough.

6. The virtual creature character fostering apparatus according to claim 1, wherein the temperature sensor is installed inside the casing with a sensor portion thereof being in contact with an inner wall surface of the casing.

7. A virtual creature character fostering apparatus comprising:
a casing onto which an image display portion is fixed;
a temperature sensor disposed inside the casing to detect a temperature of the casing;
display control means which displays an image of a virtual creature character on the image display portion, uses an output from the temperature sensor as one of growth element data for promoting the growth of the virtual creature character, determines a growing image of the virtual creature character to be displayed on the image display portion based on the growth element data, and displays the growing image on the image display portion;
timer means which counts a predetermined timer period and determines that the predetermined timer period has passed after the growing image of the virtual creature character, which has been determined, is displayed on the image display portion; and
temperature-condition determination means which determines whether or not the casing has been warmed up to a predetermined temperature after the timer means completes counting the predetermined timer period, wherein
the display control means is configured to display a subsequent growing image of the virtual creature character on the image display portion when the temperature-condition determination means determines that the casing has been warmed up to the predetermined temperature.

8. The virtual creature character fostering apparatus according to claim 7, further comprising character-to-be-fostered selecting means which outputs a selection command to select one or more virtual creature characters to be fostered among a plurality of kinds of the virtual creature characters based on the output from the temperature sensor, wherein
the display control means is configured to display an initial image of the one or more virtual creature characters on the image display portion based on the selection command, determine a growing image of the one or more virtual creature characters to be displayed on the image display portion based on the growth element data, and display the growing image on the image display portion.

9. The virtual creature character fostering apparatus according to claim 7, further comprising other temperature-condition determination means which determines whether or not the casing has been warmed up to a temperature equal to or higher than a preset temperature based on an output from the temperature sensor; the preset temperature being preset to be higher than the predetermined temperature in the temperature-condition determination means, and
image restoration command generating means which outputs to the display control means an image restoration command to restore a current display image to a very previous display image when said other temperature-condition determination means determines that the casing has been warmed up to a temperature equal to or higher than the preset temperature.

10. The virtual creature character fostering apparatus according to claim 7, wherein the predetermined temperature is above ordinary temperature and is defined based on the temperature of the casing when the casing is warmed by the body temperature of a human being.

11. The virtual creature character fostering apparatus according to claim 7, wherein the image display portion includes a display device disposed inside the casing and a view window portion disposed in the casing to allow the display device inside the casing to be viewed therethrough.

12. The virtual creature character fostering apparatus according to claim 7, wherein the temperature sensor is installed inside the casing with a sensor portion thereof being in contact with an inner wall surface of the casing.

13. A virtual creature character fostering apparatus comprising:
a casing onto which an image display portion is fixed;
a temperature sensor disposed inside the casing to detect a temperature of the casing;
display control means which displays an image of a virtual creature character on the image display portion, uses an output from the temperature sensor as one of growth element data for promoting the growth of the virtual creature character, determines a growing image of the virtual creature character to be displayed on the image display portion based on the growth element data, and displays the growing image on the image display portion;
temperature-condition determination means which determines whether or not the casing has been warmed over a given time period after the growing image of the virtual creature character, which has been determined, is displayed on the image display portion; and
timer means which counts a predetermined timer period and determines that the predetermined timer period has passed after the temperature-condition determination means determines that the casing has been warmed over the given time period, wherein
the display control means is configured to display a subsequent growing image of the virtual creature character on the image display portion after the timer means completes counting the predetermined timer period.

14. The virtual creature character fostering apparatus according to claim 13, further comprising character-to-be-fostered selecting means which outputs a selection command to select one or more virtual creature characters to be fostered among a plurality of kinds of the virtual creature characters based on the output from the temperature sensor, wherein
the display control means is configured to display an initial image of the one or more virtual creature characters on the image display portion based on the selection command, determine a growing image of the one or more virtual creature characters to be displayed on the image display portion based on the growth element data, and display the growing image on the image display portion.

15. (canceled)

16. (canceled)

17. The virtual creature character fostering apparatus according to claim 13, wherein the image display portion includes a display device disposed inside the casing and a view window portion disposed in the casing to allow the display device inside the casing to be viewed therethrough.

18. The virtual creature character fostering apparatus according to claim 13, wherein the temperature sensor is installed inside the casing with a sensor portion thereof being in contact with an inner wall surface of the casing.

19. A virtual creature character fostering apparatus comprising:
a casing onto which an image display portion is fixed;
a temperature sensor disposed inside the casing to detect a temperature of the casing;
display control means which displays an image of a virtual creature character on the image display portion, uses an output from the temperature sensor as one of growth element data for promoting the growth of the virtual creature character, determines a growing image of the virtual creature character to be displayed on the image display portion based on the growth element data, and displays the growing image on the image display portion;
temperature-condition determination means which determines whether or not the casing has been warmed up to a predetermined temperature after the growing image of the virtual creature character, which has been determined, is displayed on the image display portion; and
timer means which counts a predetermined timer period and determines that the predetermined timer period has passed after the temperature-condition determination means determines that the casing has been warmed up to the predetermined temperature, wherein
the display control means is configured to display a subsequent growing image of the virtual creature character on the image display portion after the timer means completes counting the predetermined timer period.

20. The virtual creature character fostering apparatus according to claim 19, further comprising character-to-be-fostered selecting means which outputs a selection command to select one or more virtual creature characters to be fostered among a plurality of kinds of the virtual creature characters based on an output from the temperature sensor, wherein
the display control means is configured to display an initial image of the one or more virtual creature characters on the image display portion based on the selection command, determine a growing image of the one or more virtual creature characters to be displayed on the image display portion based on the growth element data, and display the growing image on the image display portion.

21. The virtual creature character fostering apparatus according to claim 19, further comprising other temperature-condition determination means which determines whether or not the casing has been warmed up to a temperature equal to or higher than a preset temperature based on an output from the temperature sensor; the preset temperature being preset to be higher than the predetermined temperature in the temperature-condition determination means, and
image restoration command generating means which outputs to the display control means an image restoration command to restore a current display image to a very previous display image when said other temperature-condition determination means determines that the casing has been warmed up to a temperature equal to or higher than the preset temperature.

22. The virtual creature character fostering apparatus according to claim 19, wherein the predetermined temperature is above ordinary temperature and is defined based on the temperature of the casing when the casing is warmed by the body temperature of a human being.

23. The virtual creature character fostering apparatus according to claim 19, wherein the image display portion includes a display device disposed inside the casing and a view window portion disposed in the casing to allow the display device inside the casing to be viewed therethrough.

24. The virtual creature character fostering apparatus according to claim 19, wherein the temperature sensor is installed inside the casing with a sensor portion thereof being in contact with an inner wall surface of the casing.
